(19) United States
(12) Patent Application Publication
(10) Pub. No.: US 2025/0314765 A1
(43) Pub. Date: Oct. 9, 2025

(54) ACOUSTIC VECTOR SENSOR TRACKING SYSTEM

(71) Applicant: The Regents of the University of California, Oakland, CA (US)

(72) Inventors: Aaron Thode, San Diego, CA (US); Ludovic Tenorio-Hallé, Miami, FL (US); Alison Beth Laferriere, South Kingstown, RI (US)

(21) Appl. No.: 18/867,653

(22) PCT Filed: Jun. 2, 2023
(86) PCT No.: PCT/US2023/067876

§ 371 Date: Nov. 20, 2024

Related U.S. Application Data
(60) Provisional application No. 63/348,647, filed on Jun. 3, 2022.

(51) Int. Cl. G01S 15/58; G01S 7/531; G01S 15/89

(52) U.S. Cl. CPC G01S 15/588; G01S 7/531; G01S 15/89

(57) ABSTRACT

In some implementations, a method includes collecting a first set of sensor data comprising a pressure time series and at least two velocity time series collected from at least two horizontal axes, wherein the first set of sensor data is obtained from a first acoustic vector sensor; generating an azigram from the first set of sensor data obtained from the first acoustic vector sensor; generating a histogram based on the azigram; generating a first set of azimuthal estimates derived from one or more maxima of the histogram; performing azigram thresholding to generate a first set of binary images for the first set of azimuthal estimates; and transmitting the first set of binary images and the first set of azimuthal estimates to a centralized processing unit to enable object localization. Related systems, methods, and articles of manufacture are also disclosed.

### CROSS-REFERENCE TO RELATED APPLICATION

This application claims priority to U.S. Provisional Application No. 63/348,647 entitled “SURFACE VESSEL PASSIVE ACOUSTIC TRACKING SYSTEM FOR COASTAL AND HARBOR DEFENSE,” and filed on Jun. 3, 2022, which is incorporated herein by reference in its entirety.

### BACKGROUND

Most underwater acoustic monitoring has traditionally used hydrophones, which are piezoelectric sensors that detect the acoustic pressure component of a sound field. For example, a single hydrophone can detect a signal, but not derive the azimuth from which it is arriving from. As a result, systems using hydrophones may be grouped together as arrays, which permits the direction of a sound field to be determined. Unfortunately, for low frequency sounds the required spacing between hydrophones becomes unwieldy. For example, for a 100-Hz signal hydrophones need to be spaced about 7.5 meters (m) apart to measure an unambiguous direction for a sound emanating from an object, and ten hydrophones spaced across a total aperture of 75 m is needed to within a 15° (degree) uncertainty in directionality.

### SUMMARY

In some example embodiments, there may be provided a method including collecting, by a first remote unit, a first set of sensor data comprising a pressure time series and at least two velocity time series collected from at least two horizontal axes, wherein the first set of sensor data is obtained from a first acoustic vector sensor; generating, by the first remote unit, an azigram from the first set of sensor data obtained from the first acoustic vector sensor; generating, by the first remote unit, a histogram based on the azigram; generating, by the first remote unit, a first set of azimuthal estimates derived from one or more maxima of the histogram; performing, by the first remote unit, azigram thresholding to generate a first set of binary images for the first set of azimuthal estimates; and transmitting, by the first remote unit, the first set of binary images and the first set of azimuthal estimates to a centralized processing unit to enable object localization.

In some variations, one or more of the features disclosed herein including the following features can optionally be included in any feasible combination. The first remote unit may generate a normalized transport velocity image, wherein the histogram is generated based on the azigram and the normalized transport velocity image, wherein the normalized transport velocity image filters the histogram. A second remote unit may generate a second set of azimuthal estimates and a second set of binary images from a second set of sensor data collected from a second acoustic vector sensor. The transmitting may further include transmitting the second set of binary images and the second set of azimuthal estimates to the centralized processing unit to enable object localization. The first set of sensor data may be collected over at least a first time interval. The azigram may include an image generated as a function of time, frequency, and a dominant azimuth indicative of where acoustic energy is arriving. The normalized transport velocity image may include an image as a function of time, frequency, and a ratio between an active intensity and an energy density. The ratio may normalize the normalized transport velocity image between 0 and 1, such that a value closer to 1 indicates acoustic energy is clustered around a dominant azimuth. The histogram may be generated using the azigram to provide a distribution of azimuths measured across time-frequency bins in the azigram. A location of an object may be detected using at least the first set of binary images and the second set of binary images. A first magnitude of a reactive intensity vector may be compared with a second magnitude of an active intensity vector. Using a ratio of the first magnitude and the second magnitude, two objects may be determined to be present in the first set of sensor data. Two sets of pressure and particle velocities may be extracted that are unique to each of the two objects. Using directions of the active intensity vector and the reactive intensity vectors, a coordinate rotation may be determined to separate the two objects such that the two sets of pressure and particle velocities are unique to each of the two objects.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an example of a system environment for an acoustic tracking system, in accordance with some embodiments;

FIG. 2A depicts an example of a process for tracking objects, in accordance with some embodiments;

FIG. 2B depicts another example of a process for tracking objects, in accordance with some embodiments;

FIG. 3A depicts an example of a spectrogram, in accordance with some embodiments;

FIG. 3B depicts an example of an azigram, in accordance with some embodiments;

FIG. 3C depicts an example of a normalized transport velocity image, in accordance with some embodiments;

FIG. 4 depicts a plot of an azigram-based histogram, in accordance with some embodiments;

FIGS. 5 and 6 show examples of binary images derived from an azigram, in accordance with some embodiments;

FIG. 7 depicts a plot of a confusion matrix, in accordance with some embodiments;

FIG. 8 depicts how azimuths of the individual objects are determined, in accordance with some embodiments; and

FIG. 9 depicts a block diagram illustrating a computing system, in accordance with some embodiments.

### DETAILED DESCRIPTION

Unlike hydrophones, an acoustic vector sensor (also referred to as a vector sensor, for short) includes a plurality of sensors to measure both acoustic pressure p and particle velocity v along two (e.g., vₓ, v_{y}) or three orthogonal directions (vₓ, v_{y}, v_{z}). The vector nature of acoustic particle velocity allows the directionality of a sound field to be measured from a single compact acoustic vector sensor, even for low-frequency sounds with large acoustic wavelengths. Disclosed herein is a description regarding how sensor data from at least two underwater acoustic vector sensor platforms can be processed to automatically track objects, such as ocean vessels, marine mammals, and/or other types of objects, with reduced on-platform classification requirements and with low data transmission requirements to, for example, a centralized data processor. Unlike other passive acoustic tracking systems, precise time-synchronization is not required by the acoustic vector sensor platforms. Moreover, these acoustic vector sensor platforms may be mobile, moored, drifting, bottom-mounted, and/or deployed in other ways as well.

In accordance with some embodiments, a remote unit associated with each acoustic vector sensor (AVS) may collect sensor data generated by the AVS and may process that sensor data to reduce (or compress) the sensor data into tracks (e.g., azimuth information) and binary images (e.g., thresholded azigrams)—thereby reducing the amount of data sent to a central unit for detection and tracking of objects.

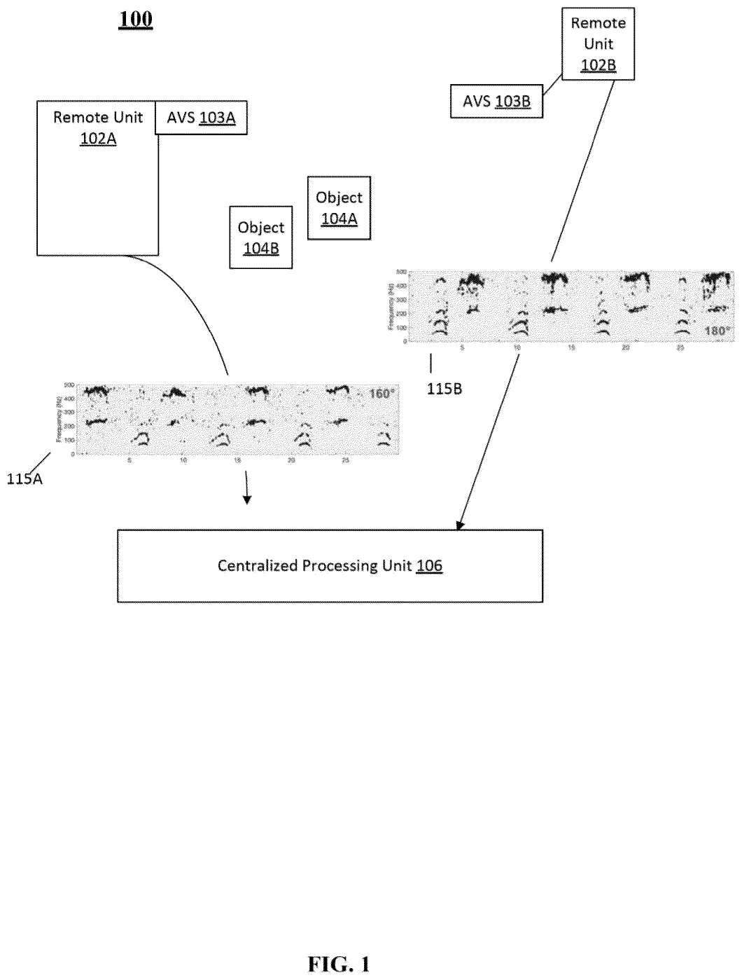

FIG. 1 depicts an example of a system 100 including at least two acoustic vector sensors (AVSs), in accordance with some embodiments. In the example, a remote unit 102A includes at least one processor (e.g., a microprocessor and/or the like) and at least one memory unit, including instructions which (when executed by the at least one processor) cause the operations disclosed herein with respect to the remote unit. The remote unit 102A may include or be coupled (via a wired and/or a wireless (which may be acoustic and/or electromagnetic) link) to one or more AVSs, such as acoustic vector sensor (AVS) 103A. The remote unit 102B may have the same or similar configuration as noted with respect to remote unit 102A. The remote unit 102B may include or be coupled (via a wired and/or a wireless (which may be acoustic and/or electromagnetic) link) to one or more AVSs, such as acoustic vector sensor (AVS) 103B. In operation for example, the AVSs may be deployed along with the remote units in a body of water, such as an ocean, lake, river, and/or the like, to receive acoustic signals corresponding to sound or seismic waves emanating from an object, such as a ship, a whale, and/or any other type of object. The remote units 102A-B may also be coupled (via a wired and/or a wireless acoustic or electromagnetic link) to a centralized processing unit 106, which includes at least one processor (e.g., a microprocessor and/or the like) and at least one memory including instructions which (when executed by the at least one processor) cause the operations disclosed herein with respect to the centralized processing unit. The remote unit 102B may be coupled to remote unit 102A.

Although FIG. 1 depicts a certain quantity and configuration of remote units, AVSs, and centralized processing unit(s), other quantities and configurations may be implemented as well.

In operations, an AVS, such as AVS 103A, may detect the acoustic (or seismic energy) corresponding to sound (or seismic waves) from one or more objects, such as an object 104A and/or object 104B. Examples of these objects include a whale, a ship, a submarine, and/or other object in a body of water, such as an ocean, lake, river, and/or the like. The acoustic (or seismic energy) of the two sources may or may not overlap in time and/or frequency. Likewise, another AVS, such as AVS 103B, may detect the acoustic (or seismic) energy (e.g., sound) from one or more objects, such as the object 104A and/or the object 104B. As noted, the AVS detects not only the sound (acoustic) pressure p of an object but also particle velocity v along for example at least two orthogonal directions (e.g., vₓ, v_{y}) or three orthogonal directions (vₓ, v_{y}, v_{z}). In accordance with some example embodiments, the remote unit(s) associated with the AVS may collect the sensor data (e.g., acoustic pressure p and particle velocity v), process the sensor data into a compact form comprising azimuths(s) and binary image(s), and then output (e.g., transmit, provide, and/or the like) the azimuths(s) and binary images 115A-B (e.g., thresholded azigram(s)) to the centralized processing unit 106, where the centralized processing unit uses the azimuths(s) and binary image(s) from at least two AVS to detect and track objects. In some embodiments, the remote units may merge temporal sequences of azimuths into tracks, which are then output to the centralized processing unit 106.

Before providing additional description regarding the AVS sensor data processing disclosed herein, the following provides a description regarding acoustic vector sensors (or, as noted, vector sensors, for short).

As noted, vector sensors are designed to measure both acoustic pressure and particle velocity along two or three orthogonal axes. The instantaneous acoustic intensity along a given axis k is defined as

$${I}_{k} = {pv}_{k} \qquad ( 1 )$$

wherein pressure p and velocity vk are the time series of acoustic pressure and particle velocity along axis k. If the acoustic field is comprised by a single plane wave arriving from a distant, dominant, and spatially compact object (which is a source of the detected acoustic signal), the magnitude of the particle velocity is proportional to and in phase with the pressure. Equation (1) may thus be reduced to a form where the squared pressure alone yields the intensity magnitude. However, since vector sensors measure pressure and particle motion independently, vector sensors provide direct measurements of the true underlying acoustic intensity, even in circumstances where the acoustic field is not dominated by a single plane wave.

The frequency-domain acoustic intensity Sₖ can be estimated at time-frequency bin (T,f) as

$${S}_{k} ( T , f ) = 〈 P ( T , f ) {V}_{k}^{*} ( T , f ) 〉 ≡ {C}_{k} ( T , f ) + {iQ}_{k} ( T , f ) \qquad ( 2 )$$

wherein P and Vₖ are short-time fast Fourier transforms (FFTs) of p and vₖ, respectively, or the output of some other short-time transformation into the frequency domain (e.g., a continuous wavelet transform, Wigner-Ville distribution, etc.). The symbol * denotes the complex conjugate of a complex number, and < > represents the ensemble average of a statistical quantity. If a time series can be considered to be statistically ergodic over a given time interval, this ensemble average can be obtained from time-averaging consecutive FFTs. In practice, ambient acoustic fields are often highly nonstationary, but a short enough time interval can typically be found where the ergodicity assumption is valid. In Equation (2), Cₖ and Qₖ are defined as the active and reactive acoustic intensities, respectively, and Cₖ and Qₖ comprise the in-phase and in-quadrature components of the pressure and particle velocity. The active intensity Cₖ comprises the portion of the field where pressure and particle velocity are in phase and are transporting acoustic energy through the measurement point. The reactive intensity Qₖ comprises the portion of the field where pressure and particle velocity are 90° (degrees) out of phase and arises whenever a spatial gradient exists in the acoustic pressure. When only one object is producing acoustic (or seismic) energy (e.g., object 104A only), the reactive component of intensity can be ignored (e.g., not used), and the active component is used to define two directional metrics: the dominant azimuth and the normalized transport velocity (NTV). When two objects are producing acoustic (or seismic energy) that overlaps in time and frequency, the reactive intensity may be used to identify the presence of two sources (e.g., two objects) and may then be used to separate the two sources in azimuth time and frequency.

In the case of a two-dimensional vector sensor that measures particle velocity along the x and y axis (e.g., vₓ, v_{y}), the dominant azimuth from which acoustic energy is arriving, φ, is defined as

$$φ ( T , f ) = {tan}^{- 1} \frac{{C}_{x} ( T , f )}{{C}_{y} ( T , f )} \qquad ( 3 )$$

wherein φ is expressed in geographical terms: increasing clockwise and starting from the y axis. The dominant azimuth can then be displayed as a function of both time and frequency as an image (or plot) referred to herein as an “azigram”. Equation (3) estimates only the dominant azimuth since acoustic energy may be arriving from different azimuths simultaneously at the measurement point. Equation (3) effectively represents an estimate of the “center of mass” of the transported energy but provides no information about its angular distribution around the vector sensor. As used herein, the term “azigram” (which is described further below) represents an image (e.g., plot) of the dominant azimuth that is displayed as a function of both time and frequency.

The phrase “normalized transport velocity” (NTV) refers to a quantity that provides the second order information about the about the acoustic field (e.g., the angular distribution of energy arriving at the vector sensor). As used herein, the normalized transport velocity (which is described further below) represents an image (or plot) of the NTV as a function of both time and frequency. For example, for the same two-dimensional vector sensor assumed for Equation (3), the NTV may be defined by a ratio between the active intensity and the energy density of the field

$$U ( T , f ) = \frac{2 {ρ}_{0} c 〈 {[ {C}_{x}^{2} ( T , f ) + {C}_{y}^{2} ( T , f ) ]}^{\frac{1}{2}} 〉}{{ρ}_{0}^{2} {c}^{2} 〈 {\vert {V}_{x} ( T , f ) \vert}^{2} + {\vert {V}_{y} ( T , f ) \vert}^{2} 〉 + 〈 {\vert P ( T , f ) \vert}^{2} 〉} \qquad ( 4 )$$

wherein p₀ and c are the density and sound speed in the medium, respectively. Equation (4) is normalized such that the NTV lies between 0 and 1. Although the NTV should be computed using particle velocity measurements along all three spatial axes, when measuring low-frequency sound in a shallow-water acoustic waveguide only a small fraction of the total acoustic energy is transported vertically (along the third, z axis) into the ocean floor. Under these circumstances, a relatively accurate NTV can be obtained on a two-dimensional sensor using only particle velocity measurements along the horizontal axes (e.g., vₓ, v_{y}). In the case of a normalized NTV as in the case of Equation (4), an NTV close to 1 implies that most of the acoustic energy traveling through the measurement point is clustered around the dominant azimuth. Such would be the case for a single azimuthally compact source, such as a whale or a ship, whose signal-to-noise ratio (SNR) is high. By contrast, a NTV of 0 indicates that no net acoustic energy is being transported through the measurement point, which implies either no acoustic energy is present at all, or equal amounts of energy are being propagated from opposite directions, as is the case for a standing wave. Thus, low transport velocity occurs in the presence of ambient fields that are either isotropic or azimuthally symmetric, even if the pressure levels generated by these sources are large.

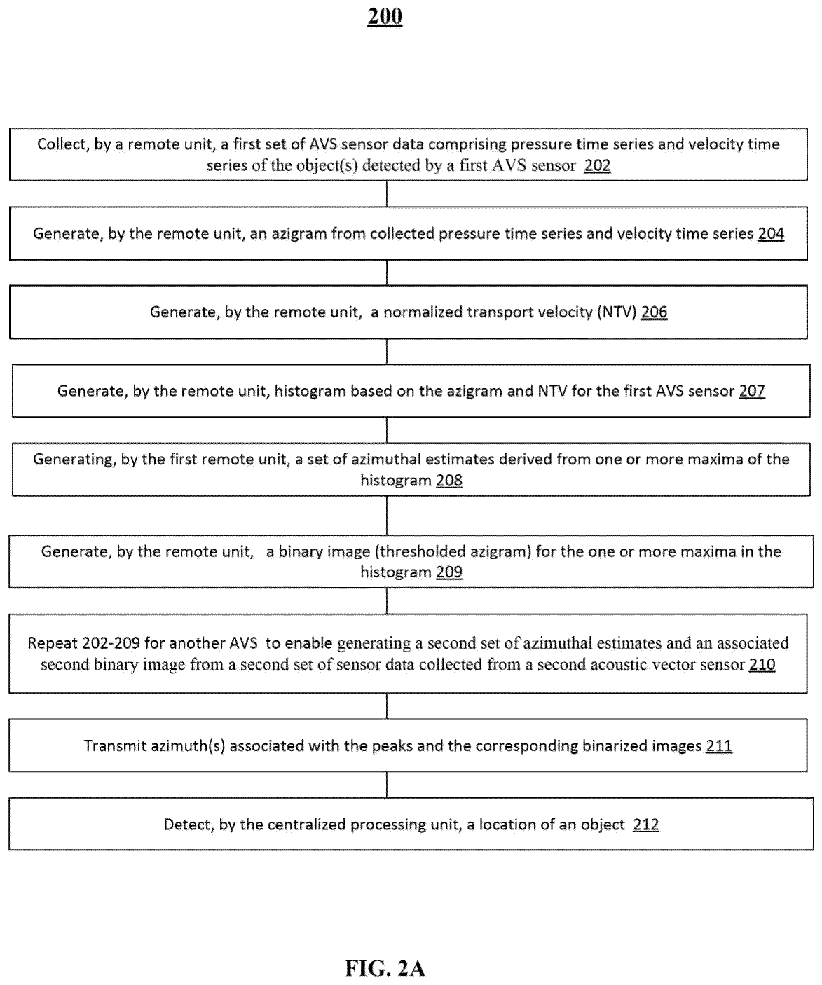

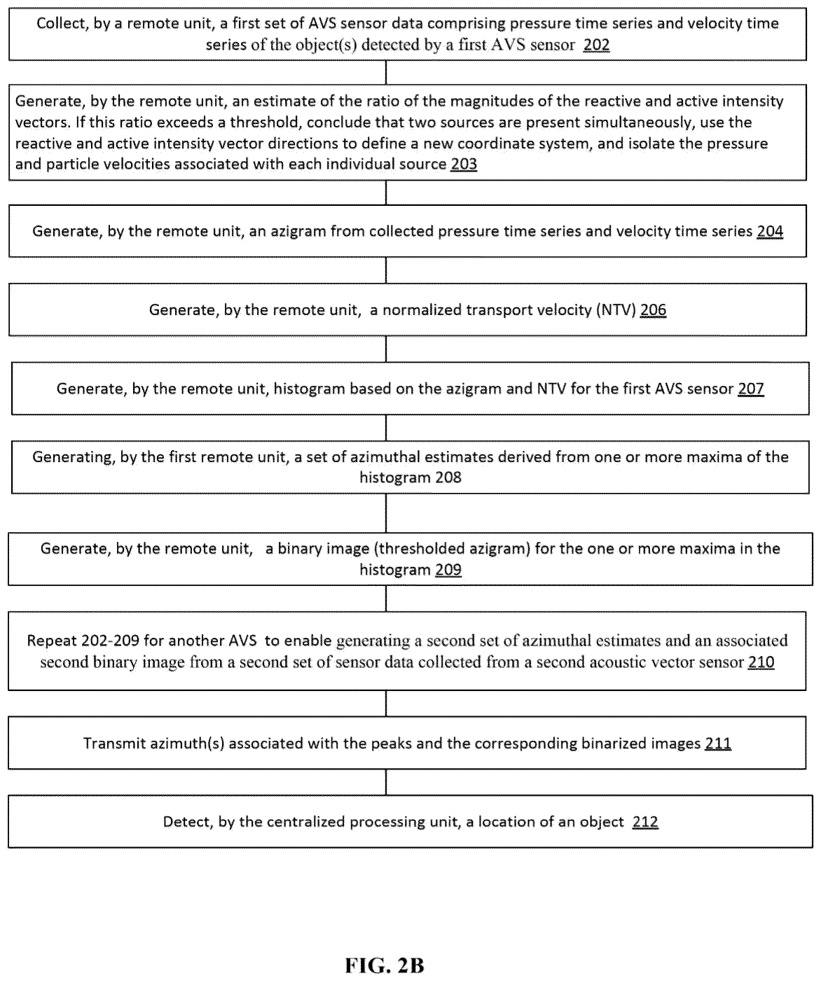

FIG. 2A depicts an example of a process 200 for tracking objects, in accordance with some embodiments.

At 202, a remote unit may collect a first set of AVS sensor data, which comprises a pressure time series of the object(s) detected by the first AVS sensor and velocity time series of the object(s) detected by the first AVS sensor. The velocity time series may include at least two dimensions, such as the horizontal axes (e.g., vₓ, v_{y}). For example, a remote unit 102A may collect (via a wired and/or wireless link) from a first AVS sensor, such as AVS 103A, a first set of AVS sensor data for a first time interval Tₕ (which may be a fixed or adaptable time interval, although the remote unit may collect AVS sensor data for additional time intervals as well) to enable detection of sound from objects, such as object 104A-B. The first time interval may be for example 1 minute (although other time intervals may be implemented as well). The time interval Tₕ chosen for processing is relatively short enough that the azimuthal position of the source relative to the sensor changes little. So for fast-moving sources such as a motorboat for example, the Tₕ may be as short as a few seconds.

To illustrate the AVS tracking system further by way of an implementation example, the AVS may comprise a Directional Frequency Analysis and Recording (DIFAR) vector sensor that includes an omnidirectional pressure sensor (e.g., 149 dB relative to 1 μPa/V at 100 Hz sensitivity) and two particle motion sensors capable of measuring the x and y components of particle velocity. The signals measured on each of the three channels may be sampled at 1 kHz with these sensors that have a maximum measurable acoustic frequency of about 450 Hz, for example. The sensitivity of the directional channels, when expressed in terms of plane wave acoustic pressure (−243.5 dB re m/s equates to 0 dB relative to 1 μPa) is about 146 dB relative to 1 μPa/V at 100 Hz. The sensitivity of all channels increases by +6 db/octave (e.g., the sensitivity of the omnidirectional channel is 143 dB relative to 1 μPa/V at 200 Hz), since the channel inputs are differentiated before being recorded.

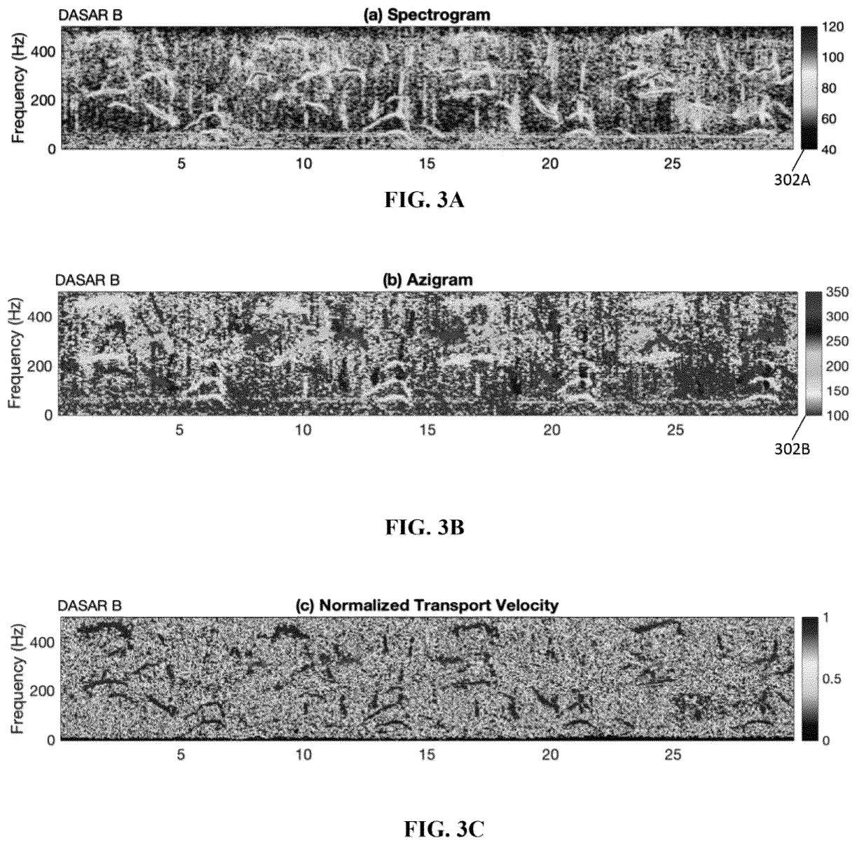

At 204, the remote unit may generate an azigram from the first AVS sensor data. For example, the remote unit 102A may generate an azigram from the sensor data collected at 202. FIG. 3B depicts an example of an azigram. As noted, the azigram represents an image or plot of the dominant azimuth that is displayed as a function of both time and frequency.

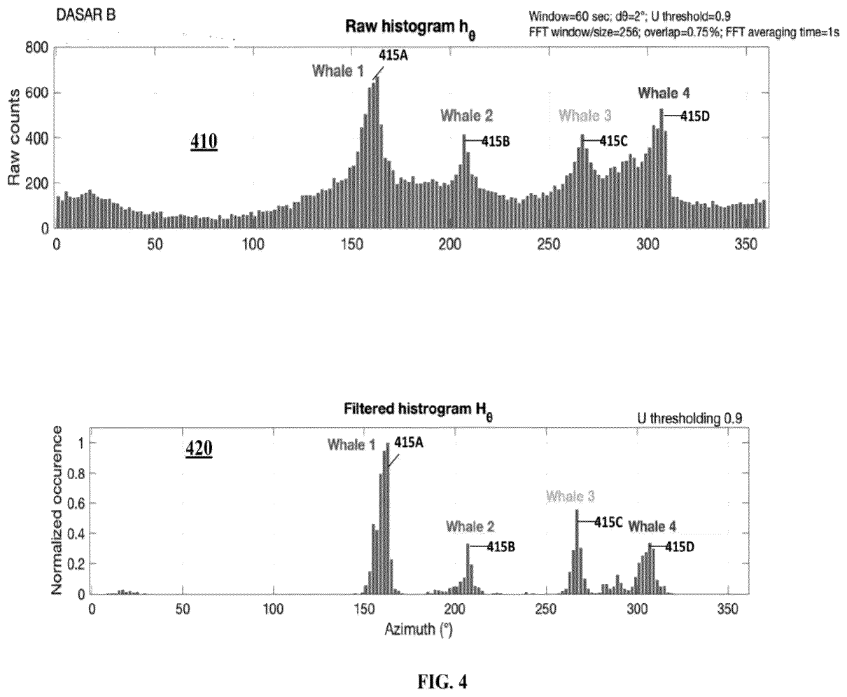

At 206, the remote unit may generate a normalized transport velocity (NTV) from the first AVS sensor data. Referring to FIG. 3B for example, the remote unit 102A may generate an NTV from the sensor data collected at 202. Alternatively, the remote unit may not generate an NTV (which is used as noted with respect to FIG. 4 to filter the histogram). When the NTV is not generated, the remote unit may use the raw histogram 410 or filter the histogram 410 using another type of filtering.

As noted above with respect to Equations (3) and (4), both the dominant azimuth φ and NTV can be associated with each time frequency bin (T, f) of a spectrogram, so these quantities of φ and NTV may be displayed as an image (or plot). Referring to FIG. 3A, a spectrogram is presented with the received sensor data plotted as a function of frequency versus time, where the intensity (e.g., sound pressure in dB) is a third dimension such as color or gray scale 302A. Referring to FIG. 3B, an azigram is plotted as a function with the received sensor data plotted as a function of frequency versus time but the dominant azimuth of the received acoustic signal is a third dimension such as color or gray scale 302B. In the dominant azimuth representation of the azigram of FIG. 3B, the color (or gray scale) of each pixel is associated with a given geographical azimuth (e.g., the dominant azimuth from which acoustic energy is arriving φ). Referring to FIG. 3C, the NTV image is plotted as a function of frequency versus time, where the color/gray scale 302C of each pixel corresponds to a value between 0 and 1. As noted above with respect to Equation 4, an NTV close to 1 implies that most of the acoustic energy traveling through the measurement point is clustered around the dominant azimuth as would be the case for a single azimuthally compact source (e.g., whale or a ship), whose signal-to-noise ratio (SNR) is high. In the example of FIGS. 3A-3C, the spectrogram of FIG. 3A suggests the presence of objects, such as sounds from multiple humpback whales singing simultaneously, but the spectrogram does not allow a straightforward association of song units to individual whales. By contrast, the azigram of FIG. 3B reveals distinct individual whales based on their azimuth (which is indicated by the third dimension, color that plots azimuth between 100° and 350° azimuth). And the NTV plot of FIG. 3C shows that the whale's calls have high NTV values as would be expected from a spatially compact acoustic source. The time interval associated with each image may correspond to the first time interval Tₕ. As an object such as a whale moves relatively slowly, the Tₕ (in the case of a slow moving object such as a whale) has been set to a relatively large value of 30 seconds.

At 207, the remote unit may generate a histogram based on the generated azigrams and NTV. For example, the number of objects, such as the singing whales noted above, and their azimuths can be estimated over the time interval Tₕ from a statistical distribution of φ (which is plotted as an azigram in FIG. 3B). Let h₀(ΔTₕ) be defined as a histogram that counts the number of observations of φ(T,f) that fall within azimuthal bin of center 0 and width d0 within the time interval ΔTₕ, so h₀ estimates the distribution of azimuths measured across all time-frequency bins in the azigram (where the histogram time window ΔTₕ should be long enough for the azigram to include sound from all sources and short enough for any shifts in an the sources' azimuths to be negligible). To minimize contributions to h₀ from diffuse background noise and other non-directional sources, an NTV threshold may also be applied so that any observation φ(T,f) associated with an NTV below a threshold NTV value γ_{U} is discarded from the histogram. In this example, the remote unit generates the histogram computed from the azigram of FIG. 3B but using only with azimuthal values whose NTV is above the threshold NTV value γ_{U} of the NTV of FIG. 3C. Combining the azigram with the NTV image (by filtering the azigram based on the NTV threshold value) results in a filtered histogram H₀(ΔTₕ) that emphasizes azimuths that are associated with highly directional compact sources, such as whales and boats. The histogram H₀ is normalized by its maximum value so that the bin associated with the most likely azimuth is scaled to 1. FIG. 4 at 410 plots the azigram-based histogram before filtering and at 420 after applying the NTV threshold and normalization, which illustrates how the filtering enhances the azimuths associated with four objects, such as 4 distinct whales. The remote unit identifies the number of sources present based on the number of local maxima present in H₀. In other words, the local maximas 415A-D represent local peaks.

At 208, the first remote unit may generate a set of azimuthal estimates derived from one or more maxima of the histogram. Referring to FIG. 4, the maxima 415A-D may each correspond to an object and a corresponding azimuth (e.g., the maxima 415A corresponds to a whale at about 160 degrees, the maxima 415B corresponds to a whale at about 220 degrees, and so forth). The azimuths (see, e.g., x axis) for the maximums (e.g., peaks/maxima at 415A-D) may be used as the set of azimuthal estimates.

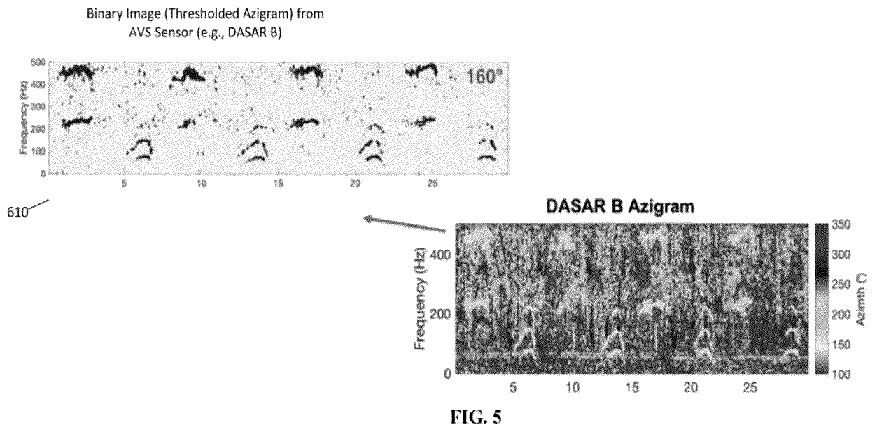

Referring again to FIG. 2A, the remote unit may, at 209, generate a binary image for one or more maxima in the histogram. For example, this operation may be performed using a maximum of the histogram. The thresholding may be applied to an azigram to create a binary image (also referred to as thresholded azigram) using an azimuthal sector (which is determined from the azimuth of a maxima of the histogram) of a threshold width dφ. In other words, an azigram, such as the azigram of FIG. 3A, is thresholded based on the azimuth estimates obtained from H₀ in 208 (see, e.g., azimuths associated with maxima 415A-D at 420 of FIG. 4). This thresholding creates a binary image, one for each local peak identified at 207 (e.g., peaks 215A-D) and allows the time-frequency characteristics of an object (e.g., ship, whale calls, etc.) arriving from a specific azimuth to be isolated using the different AVSs. This image thresholding process based on azimuth is referred to herein as “azigram thresholding.” An example of the binary image 610 created via the azigram threshold is depicted at FIG. 5, and the binary image may be further processed with a filter to remove for example speckle components of the image.

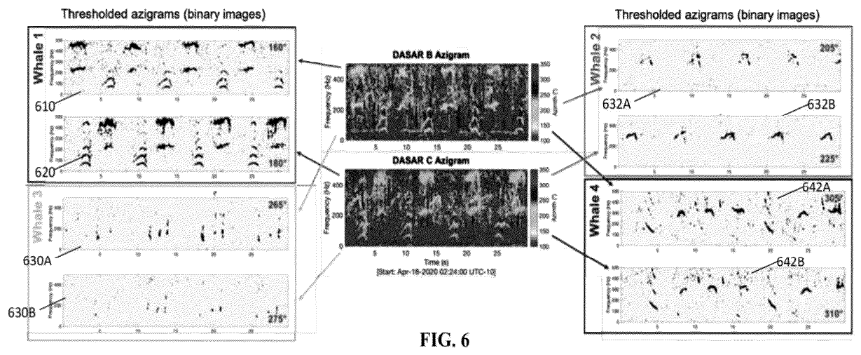

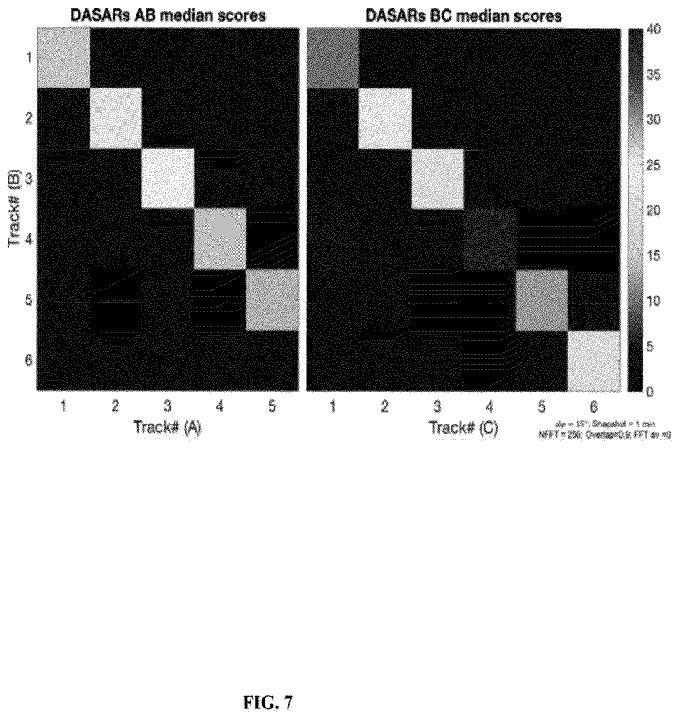

Referring to FIG. 5 for example, an object is detected at an azimuth of 160 degrees (which corresponds to a maxima 415A's azimuth at FIG. 4, for example) and azigram thresholding generates the binary image 610 so that only objects in the 160 degree azimuth have a value of 1 while other objects have a value of 0 (providing the binarized image at 610). Referring to FIG. 6, for any given time and AVS sensor (labeled DASAR B and C), the azimuth associated with the local peaks in FIG. 4 (415A-D) can be used to threshold the corresponding azigram on a sensor α and isolate the object(s), such as the whale and the corresponding song units of whale n. FIG. 6 demonstrates examples of four whale songs (which is sound emanated contemporaneously and detected in this example) extracted from DASARs B and C. The 30 second time window presented at FIG. 6 corresponds to the first half of the histograms shown in FIG. 4.

At 210, the noted process at 202-209 may be repeated for another sensor, which yields another filtered histogram H₀ and associated binary images created by azigram thresholding. For example, the processes 202-209 may repeat for AVS sensor 103B, so the remote unit 102B may collect the sensor data from the objects 104A-B and so forth as noted at 202-209 above. By repeating 202-209, a second remote unit, such as remote unit 102B, may generate a second set of azimuthal estimates and an associated second set of binary image(s) from a second set of sensor data collected from a second acoustic vector sensor, such as the AVS sensor 103B.

In the example of FIG. 6B, a remote unit transmits, at 211, to the centralized data processor 106 (via a wired and/or wireless link(s)) the azimuths (which are associated with the peaks (such as 160°, 265°, 205°, and 305°) and the corresponding binarized images (e.g. 610, 630A, 632A, and 642A). For example, a first remote unit, such as remote unit 102A may transmit to the centralized processing unit 106 the first set of azimuthal estimates (160°, 265°, 205°, and 305°) and the corresponding binary images (610, 630A, 632A, and 642A). Likewise, a second remote unit, such as remote unit 102B may transmit to the centralized processing unit 106 a second set of azimuthal estimates (180°, 275°, 225°, and 310°) and their corresponding binary images (620, 630B, 632B, 642B), which were generated by the second remote unit at 210.

At 212, the centralized processing unit 106 may detect a location of an object using at least the first set of binary images and the second set of binary images. For example, the centralized processing unit 106 detect objects and may locate the objects by for example comparing and matching the binary images at a given azimuth with other binary images at a given azimuth to locate and/or track objects. For example, Bα(T,f) and B_{β}(T,f) may be two binary images covering the same time interval Tₕ, obtained from applying azigram thresholding to AVSs (e.g., DASARs) α and β, respectively. The azimuthal sector used to produce the images may differ between the AVS platforms as shown at FIG. 6B, for example. The similarity of the two binary images may be quantified by taking a maximum value of the cross correlation between Bα and B_{β} along time, expressed as

$$R = {max}_{τ} \{ {\sum }_{f} {\sum }_{T} {B}_{α} ( T , f ) {B}_{β} ( T + τ , f ) \} \qquad ( 5 )$$

where τ is the cross correlation time delay. R can be normalized into a “cross correlation score” as

$$\overline{R} = \frac{100}{max \{ [ {P}_{α} , {P}_{β} ] \}} R \qquad ( 6 )$$

wherein Pα and P_{β} are the total number of positive pixels shared by Bα and B_{β}, respectively. Equation (6) normalizes the cross correlation score between any two images to lie between 0 and 100. Cross correlating binary images is conceptually similar to “spectrogram correlation” methods used to detect stereotyped baleen whale calls. Other quantitative metrics can be used to quantify the similarity between two images. For example, the effective bandwidth or time-bandwidth product of the time/frequency structure in a binary image can be computed and compared with those of other binary images.

For any time window Tₕ that reports azimuthal detections on two AVSs (e.g., DASAR B and C of FIG. 6B), the likelihood of these detections being related can be assessed by computing their cross correlation or other metric of similarity. For comparing humpback whale calls in this dataset, a time window of ΔTₕ=60 s and an azimuthal sector of dφ=15° (which corresponds to the azimuthal uncertainty) can be used. By computing the cross-correlation score of each binary image correlation, the likelihood of any two azimuthal detections being from the same source can be identified. The median scores for all combinations of detections between DASAR B and other AVSs (e.g., DASARs A and C) can be used to create confusion matrices as shown at FIG. 7. The correct associations (along the diagonal of the confusion matrices) consistently produce the highest scores. Based on this analysis, a score above 15 is associated with a correct match between detections.

In some implementations, 202-212 may take place over a single time window Tₕ. The process (202-212) may then be repeated for another time window Tₕ₊₁ that may occur immediately after the previous time window ends or after some time delay. During every time interval, each AVS produces a set of azimuths and associated binary images. The centralized processing unit may choose to accumulate results from several time windows before generating a final set of localization estimates and apply tracing methods to a sequence of azimuths to generate an azimuthal track that may provide a more robust estimate of source azimuths over multiple time windows.

In some implementations, the similarity in signal bandwidth or time-bandwidth product between two images may be used to estimate the likelihood of any two azimuthal detections being from the same source.

FIG. 2B depicts another example of a process 299 for tracking objects, in accordance with some embodiments. FIG. 2B is the same or similar to FIG. 2A in some respects but further includes generating an estimate of the ratio of the magnitudes of the reactive and active intensity vectors as shown at 203. If this ratio exceeds a threshold, the remote unit determines (concludes), the two sources (e.g., two objects) are present simultaneously, uses the reactive and active intensity vector directions to define a new coordinate system, and isolates (e.g., extracts) the pressure and particle velocities associated with each individual source (203). Specifically, 203 may be performed on each sensor's data before azigrams are computed (204). This additional aspect can be performed in situations where objects 104A and 104B produce sounds (or seismic signals) that overlap in time and frequency. During 203 the remote unit compares the magnitude of the reactive intensity vector |Q_{T}| with the magnitude of the active intensity vector |C_{T}|, with the components of C_{T} and Q_{T} defined by Equation (2). Q_{T} will be close to zero only when a single acoustic source is present at a given time and frequency, or if no discrete sources are present at all. However, if two sources are present, they produce an interference pattern that generates a non-zero value of Q_{T}. Thus when the magnitude of the reactive intensity relative to the active intensity exceeds a certain threshold, the remote unit flags the presence of two sources.

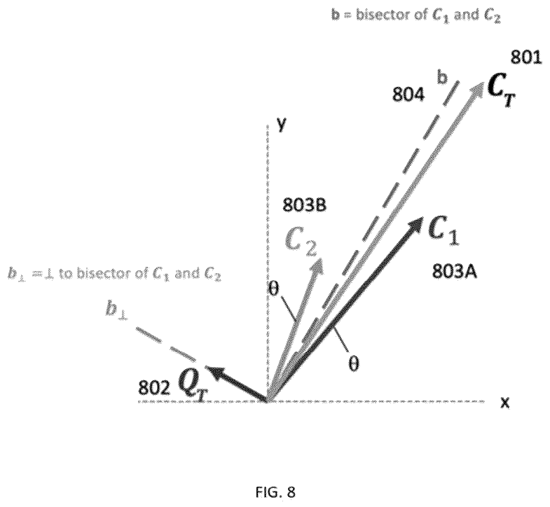

If 203 determines that a significant reactive intensity is present, it uses the geometry of FIG. 8 to determine the azimuths of the individual sources. The directions of the vectors Q_{T} (802) and C_{T} (801) identify the line (804) that bisects the angle formed by the two wavevectors associated with the planewaves arriving from two sources (803A and 803B), even when the sources have unequal acoustic amplitudes. Specifically, the bisector (804) lies in the plane defined by (801) and (802), and the bisector is perpendicular to (802). The original coordinate frame is then rotated such that Q_{T} (802) defines the vertical axis and the bisector (804) defines the horizontal axis. In this rotated coordinate frame the horizontal and vertical particle velocities are \tilde{V}ₓ and \tilde{V}_{y}, and \tilde{C}_{T} is the rotated active intensity vector. The ratio of the horizontal component of \tilde{C}_{T} to the square of the pressure magnitude provides the cosine of half the angular separation between the two wavenumbers (θ):

$$θ ( T , f ) = {cos}^{- 1} [ ρ c ( \frac{{\tilde{C}}_{T , x} ( T , f )}{{\vert P ( T , f ) \vert}^{2}} ) ] . \qquad ( 7 )$$

Here ρ and c are the medium density and sound speed respectively, and the variables are shown to explicitly depend on time T and frequency f.

The ratio of \tilde{V}_{y} to \tilde{V}_{y}, times the cotangent of (θ), yields a value that solves for the complex ratio (A) of the amplitudes of the two sources:

$$L ( T , f ) = \frac{{\tilde{V}}_{y} ( T , f )}{{\tilde{V}}_{x} ( T , f )} cot [ θ ( T , f ) ] , A ( T , f ) = \frac{1 - L ( T , f )}{1 + L ( T , f )} . \qquad ( 8 )$$

The amplitude of the complex value A provides the ratio of the magnitudes of the two sources, and the phase of A provides their relative phase. Finally, Step 203 concludes by using the measurements of the total pressure, particle velocity, and A to extract the pressures and particle velocities of the two sources, which produces the active intensities of the original sources (803A and 803B). Steps 204-209 can then be applied to each set of pressures and particle velocities as described previously.

For example, the remote unit may generate an estimate of the vectors for active intensity and reactive intensity, generate, using a ratio of the magnitudes of the reactive and active intensities, a decision that two acoustic sources (objects) are present simultaneously at the same frequency, and generate, using the directions of the active and reactive intensity vectors, an estimate of a line bisecting the wave numbers of the two sources. Next, the remote unit may perform a coordinate rotation that shifts the bisector to the horizontal axis and the reactive intensity to the vertical axis. Next, the remote unit may generate estimates of the angular separation between the sources and the relative amplitude and phase of the two sources and generate for the two sets of pressure and particle velocities unique to each source. In this way, a remote unit can separate or extract sensor data from two objects by at least comparing a first magnitude of a reactive intensity vector with a second magnitude of an active intensity vector; determining, using a ratio of the first magnitude and the second magnitude, two objects are present in the collected first sensor data using a ratio of the first magnitude and the second magnitude exceeds a threshold; and extract (e.g., determine) two sets of pressure and particle velocities unique to each of the two objects.

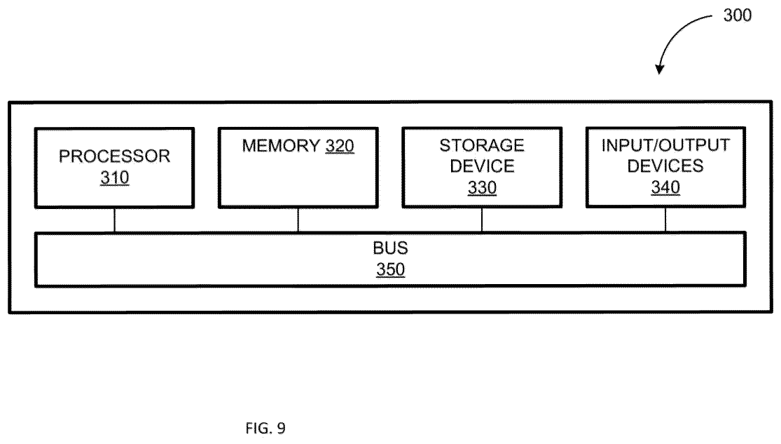

FIG. 9 depicts a block diagram illustrating a computing system 300 consistent with implementations of the current subject matter. The computing system 300 can be used to implement at least a portion of the disclosed signal processing algorithm disclosed herein. For example, the computing system may be implemented at the remote unit, AVS, and/or centralized processing unit. Although FIG. 1 depicts the centralized processing unit being separate from the remote units, a remote unit may be configured to provide the centralized processing unit (in which case for example a remote unit would transmit at 218 to the remote unit providing centralized data processing unit).

As shown, the computing system 300 can include a processor 310, a memory 320, a storage device 330, and input/output devices 340. The processor 310, the memory 320, the storage device 330, and the input/output devices 340 can be interconnected via a system bus 350. The processor 310 is capable of processing instructions for execution within the computing system 300. In some implementations of the current subject matter, the processor 310 can be a single-threaded processor. Alternately, the processor 310 can be a multi-threaded processor. Alternately, or additionally, the processor 310 can be a multi-processor core. The processor 310 is capable of processing instructions stored in the memory 320 and/or on the storage device 330 to display graphical information for a user interface provided via the input/output device 340. The memory 320 is a computer readable medium such as volatile or non-volatile that stores information within the computing system 300. The memory 320 can store data structures representing configuration object databases, for example. The storage device 330 is capable of providing persistent storage for the computing system 300. The storage device 330 can be a solid-state device, a floppy disk device, a hard disk device, an optical disk device, a tape device, and/or any other suitable persistent storage means. The input/output device 340 provides input/output operations for the computing system 300. In some implementations of the current subject matter, the input/output device 340 includes a keyboard and/or pointing device. In various implementations, the input/output device 340 includes a display unit for displaying graphical user interfaces. According to some implementations of the current subject matter, the input/output device 340 can provide input/output operations for a network device. For example, the input/output device 340 can include Ethernet ports or other networking ports to communicate with one or more wired and/or wireless networks (e.g., a local area network (LAN), a wide area network (WAN), the Internet).

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:
Example 1. A method comprising: collecting, by a first remote unit, a first set of sensor data comprising a pressure time series and at least two velocity time series collected from at least two horizontal axes, wherein the first set of sensor data is obtained from a first acoustic vector sensor; generating, by the first remote unit, an azigram from the first set of sensor data obtained from the first acoustic vector sensor; generating, by the first remote unit, a histogram based on the azigram; generating, by the first remote unit, a first set of azimuthal estimates derived from one or more maxima of the histogram; performing, by the first remote unit, azigram thresholding to generate a first set of binary images for the first set of azimuthal estimates; and transmitting, by the first remote unit, the first set of binary images and the first set of azimuthal estimates to a centralized processing unit to enable object localization.
Example 2. The method of Example 1 further comprising: generating, by the first remote unit, a normalized transport velocity image, wherein the histogram is generated based on the azigram and the normalized transport velocity image, wherein the normalized transport velocity image filters the histogram.
Example 3. The method of any of Examples 1-2 further comprising: generating, by a second remote unit, a second set of azimuthal estimates and a second set of binary images from a second set of sensor data collected from a second acoustic vector sensor.
Example 4. The method of any of Examples 1-3, wherein the transmitting further comprises transmitting the second set of binary images and the second set of azimuthal estimates to the centralized processing unit to enable object localization.
Example 5. The method of any of Examples 1-4, wherein the first set of sensor data is collected over at least a first time interval.
Example 6. The method of any of Examples 1-5, wherein the azigram comprises an image generated as a function of time, frequency, and a dominant azimuth indicative of where acoustic energy is arriving.
Example 7. The method of any of Examples 1-6, wherein the normalized transport velocity image comprises an image as a function of time, frequency, and a ratio between an active intensity and an energy density.
Example 8. The method of any of Examples 1-7, wherein the ratio normalizes the normalized transport velocity image between 0 and 1, such that a value closer to 1 indicates acoustic energy is clustered around the dominant azimuth.
Example 9. The method of any of Examples 1-8, wherein the histogram is generated using the azigram to provide a distribution of azimuths measured across time-frequency bins in the azigram.
Example 10. The method of any of Examples 1-9 further comprising: detecting a location of an object using at least the first set of binary images and the second set of binary images.
Example 11. The method of any of Examples 1-10 further comprising: comparing a first magnitude of a reactive intensity vector with a second magnitude of an active intensity vector; determining, using a ratio of the first magnitude and the second magnitude, that two objects are present in the first set of sensor data; and extracting two sets of pressure and particle velocities that are unique to each of the two objects.
Example 12. The method of any of Examples 1-1 further comprising: determining, using directions of the active intensity vector and the reactive intensity vectors, a coordinate rotation to separate the two objects such that the two sets of pressure and particle velocities are unique to each of the two objects.
Example 13. A system comprising: at least one processor; and at least one memory including instructions which when executed by the at least one processor causes operations comprising: collecting, by a first remote unit, a first set of sensor data comprising a pressure time series and at least two velocity time series collected from at least two horizontal axes, wherein the first set of sensor data is obtained from a first acoustic vector sensor; generating, by the first remote unit, an azigram from the first set of sensor data obtained from the first acoustic vector sensor; generating, by the first remote unit, a histogram based on the azigram; generating, by the first remote unit, a first set of azimuthal estimates derived from one or more maxima of the histogram; performing, by the first remote unit, azigram thresholding to generate a first set of binary images for the first set of azimuthal estimates; and transmitting, by the first remote unit, the first set of binary images and the first set of azimuthal estimates to a centralized processing unit to enable object localization.
Example 14. The system of Example 13 further comprising: generating, by the first remote unit, a normalized transport velocity image, wherein the histogram is generated based on the azigram and the normalized transport velocity image, wherein the normalized transport velocity image filters the histogram.
Example 15. The system of any of Examples 13-14 further comprising: generating, by a second remote unit, a second set of azimuthal estimates and a second set of binary images from a second set of sensor data collected from a second acoustic vector sensor.
Example 16. The system of any of Examples 13-15, wherein the transmitting further comprises transmitting the second set of binary images and the second set of azimuthal estimates to the centralized processing unit to enable object localization.
Example 17. The system of any of Examples 13-16, wherein the first set of sensor data is collected over at least a first time interval.
Example 18. The system of any of Examples 13-17, wherein the azigram comprises an image generated as a function of time, frequency, and a dominant azimuth indicative of where acoustic energy is arriving.
Example 19. The system of any of Examples 13-18, wherein the normalized transport velocity image comprises an image as a function of time, frequency, and a ratio between an active intensity and an energy density.
Example 20. The system of any of Examples 13-19, wherein the ratio normalizes the normalized transport velocity image between 0 and 1, such that a value closer to 1 indicates acoustic energy is clustered around the dominant azimuth.
Example 21. The system of any of Examples 13-20, wherein the histogram is generated using the azigram to provide a distribution of azimuths measured across time-frequency bins in the azigram.
Example 22. The system of any of Examples 13-21 further comprising: detecting a location of an object using at least the first set of binary images and the second set of binary images.
Example 23. The system of any of Examples 13-22 further comprising: comparing a first magnitude of a reactive intensity vector with a second magnitude of an active intensity vector; determining, using a ratio of the first magnitude and the second magnitude, that two objects are present in the first set of sensor data; and extracting two sets of pressure and particle velocities that are unique to each of the two objects.
Example 24. The system of any of Examples 13-23 further comprising: determining, using directions of the active intensity vector and the reactive intensity vectors, a coordinate rotation to separate the two objects such that the two sets of pressure and particle velocities are unique to each of the two objects.
Example 25. A non-transitory computer-readable storage medium comprising instructions which when executed by at least one processor causes operations comprising: collecting, by a first remote unit, a first set of sensor data comprising a pressure time series and at least two velocity time series collected from at least two horizontal axes, wherein the first set of sensor data is obtained from a first acoustic vector sensor; generating, by the first remote unit, an azigram from the first set of sensor data obtained from the first acoustic vector sensor; generating, by the first remote unit, a histogram based on the azigram; generating, by the first remote unit, a first set of azimuthal estimates derived from one or more maxima of the histogram; performing, by the first remote unit, azigram thresholding to generate a first set of binary images for the first set of azimuthal estimates; and transmitting, by the first remote unit, the first set of binary images and the first set of azimuthal estimates to a centralized processing unit to enable object localization.
Example 26. A method comprising: comparing a first magnitude of a reactive intensity vector with a second magnitude of an active intensity vector; determining, using a ratio of the first magnitude and the second magnitude, that two objects are present in a first set of sensor data; and extracting two sets of pressure and particle velocities that are unique to each of the two objects.
Example 26. A method comprising: comparing a first magnitude of a reactive intensity vector with a second magnitude of an active intensity vector; determining, using a ratio of the first magnitude and the second magnitude, that two objects are present in a first set of sensor data; and extracting two sets of pressure and particle velocities that are unique to each of the two objects.

Example 26. A system comprising: at least one processor; and at least one memory including instructions which when executed by the at least one processor causes operations comprising comparing a first magnitude of a reactive intensity vector with a second magnitude of an active intensity vector; determining, using a ratio of the first magnitude and the second magnitude, that two objects are present in a first set of sensor data; and extracting two sets of pressure and particle velocities that are unique to each of the two objects.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

1. A method comprising:
collecting, by a first remote unit, a first set of sensor data comprising a pressure time series and at least two velocity time series collected from at least two horizontal axes, wherein the first set of sensor data is obtained from a first acoustic vector sensor;
generating, by the first remote unit, an azigram from the first set of sensor data obtained from the first acoustic vector sensor;
generating, by the first remote unit, a histogram based on the azigram;
generating, by the first remote unit, a first set of azimuthal estimates derived from one or more maxima of the histogram;
performing, by the first remote unit, azigram thresholding to generate a first set of binary images for the first set of azimuthal estimates; and
transmitting, by the first remote unit, the first set of binary images and the first set of azimuthal estimates to a centralized processing unit to enable object localization.

2. The method of claim 1, further comprising:
generating, by the first remote unit, a normalized transport velocity image, wherein the histogram is generated based on the azigram and the normalized transport velocity image, wherein the normalized transport velocity image filters the histogram.

3. The method of claim 1, further comprising:
generating, by a second remote unit, a second set of azimuthal estimates and a second set of binary images from a second set of sensor data collected from a second acoustic vector sensor.

4. The method of claim 3, wherein the transmitting further comprises transmitting the second set of binary images and the second set of azimuthal estimates to the centralized processing unit to enable object localization.

5. The method of claim 1, wherein the first set of sensor data is collected over at least a first time interval.

6. The method of claim 1, wherein the azigram comprises an image generated as a function of time, frequency, and a dominant azimuth indicative of where acoustic energy is arriving.

7. The method of claim 2, wherein the normalized transport velocity image comprises an image as a function of time, frequency, and a ratio between an active intensity and an energy density.

8. The method of claim 7, wherein the ratio normalizes the normalized transport velocity image between 0 and 1, such that a value closer to 1 indicates acoustic energy is clustered around a dominant azimuth.

9. The method of claim 1, wherein the histogram is generated using the azigram to provide a distribution of azimuths measured across time-frequency bins in the azigram.

10. The method of claim 1, further comprising:
detecting a location of an object using at least the first set of binary images and the second set of binary images.

11. The method of claim 1, further comprising:
comparing a first magnitude of a reactive intensity vector with a second magnitude of an active intensity vector;
determining, using a ratio of the first magnitude and the second magnitude, that two objects are present in the first set of sensor data; and
extracting two sets of pressure and particle velocities that are unique to each of the two objects.

12. The method of claim 11, further comprising:
determining, using directions of the active intensity vector and the reactive intensity vectors, a coordinate rotation to separate the two objects such that the two sets of pressure and particle velocities are unique to each of the two objects.

13. A system comprising:
at least one processor; and
at least one memory including instructions which when executed by the at least one processor causes operations comprising:
collecting, by a first remote unit, a first set of sensor data comprising a pressure time series and at least two velocity time series collected from at least two horizontal axes, wherein the first set of sensor data is obtained from a first acoustic vector sensor;
generating, by the first remote unit, an azigram from the first set of sensor data obtained from the first acoustic vector sensor;
generating, by the first remote unit, a histogram based on the azigram;
generating, by the first remote unit, a first set of azimuthal estimates derived from one or more maxima of the histogram;
performing, by the first remote unit, azigram thresholding to generate a first set of binary images for the first set of azimuthal estimates; and
transmitting, by the first remote unit, the first set of binary images and the first set of azimuthal estimates to a centralized processing unit to enable object localization.

14. The system of claim 13, further comprising:
generating, by the first remote unit, a normalized transport velocity image, wherein the histogram is generated based on the azigram and the normalized transport velocity image, wherein the normalized transport velocity image filters the histogram.

15. The system of claim 13, further comprising:
generating, by a second remote unit, a second set of azimuthal estimates and a second set of binary images from a second set of sensor data collected from a second acoustic vector sensor.

16. The system of claim 15, wherein the transmitting further comprises transmitting the second set of binary images and the second set of azimuthal estimates to the centralized processing unit to enable object localization.

17. The system of claim 13, wherein the first set of sensor data is collected over at least a first time interval.

18. The system of claim 13, wherein the azigram comprises an image generated as a function of time, frequency, and a dominant azimuth indicative of where acoustic energy is arriving.

19. The system of claim 14, wherein the normalized transport velocity image comprises an image as a function of time, frequency, and a ratio between an active intensity and an energy density.

20. The system of claim 19, wherein the ratio normalizes the normalized transport velocity image between 0 and 1, such that a value closer to 1 indicates acoustic energy is clustered around a dominant azimuth.

21-25. (canceled)
